(19) United States
(12) Patent Application Publication
(10) Pub. No.: US 2016/0057768 A1
(43) Pub. Date: Feb. 25, 2016

(54) METHOD AND NETWORK NODE FOR DOWNLINK SCHEDULING IN A MOBILE COMMUNICATION NETWORK

(71) Applicant: TELEFONAKTIEBOLAGET L M ERICSSON (PUBL), Stockholm (SE)

(72) Inventors: Ying Sun, Sundbyberg (SE); Jianwei Zhang, Stockholm (SE)

(73) Assignee: TELEFONAKTIEBOLAGET L M ERICSSON (PUBL), Stockholm (SE)

(21) Appl. No.: 14/780,778

(22) PCT Filed: May 3, 2013
(86) PCT No.: PCT/SE2013/050489

§ 371 Date: Sep. 28, 2015

(51) Int. Cl. H04W 72/12; H04L 5/00; H04W 16/32

(52) U.S. Cl. CPC H04W 72/1273; H04W 16/32; H04L 5/0025; H04W 72/1247; H04W 72/121; H04W 72/1231

(57) ABSTRACT

The present disclosure relates to a method in a scheduling node for selecting a downlink resource allocation scheme in a mobile communication network including a plurality of at least partially overlapping sectors. The selected downlink resource allocation scheme is applicable to downlink transmission in at least a current transmission time interval to user equipments located in a one or more of the plurality of at least partially overlapping sectors. The disclosed method comprises the step of selecting a set of user equipments connected to the scheduling node. For each user equipment in the selected set of user equipments, the method further comprises the step of determining sector isolation properties of each sector. A downlink resource allocation scheme is selected wherein at least one sector is disabled for downlink transmission to user equipment in the set of user equipments based on determined sector isolation properties. The disclosure also relates to a method of allocating downlink data transmission resources in a mobile communication network, a scheduling node and a computer program comprising computer program code executed in the scheduling node.

### TECHNICAL FIELD

The present disclosure relates to a method for selecting a downlink resource allocation scheme in a scheduling node of a mobile communication network and a scheduling node performing said method. In particular the disclosure relates to scheduling downlink resources in a mobile communication network including a plurality of at least partly overlapping sectors, e.g. in a heterogeneous network.

### BACKGROUND

3GPP Long Term Evolution, LTE, is the fourth-generation mobile communication technologies standard developed within the 3rd Generation Partnership Project, 3GPP, to improve the Universal Mobile Telecommunication System, UMTS, standard to cope with future requirements in terms of improved services such as higher data rates, improved efficiency, and lowered costs. The Universal Terrestrial Radio Access Network, UTRAN, is the radio access network of a UMTS and Evolved UTRAN, E-UTRAN, is the radio access network of an LTE system. In an UTRAN and an E-UTRAN, a User Equipment, UE, is wirelessly connected to a Radio Base Station, RBS, commonly referred to as a NodeB, NB, in UMTS, and as an evolved NodeB, eNodeB or eNodeB, in LTE. An RBS is a general term for a radio network node capable of scheduling transmission to and from a user equipment and transmitting radio signals to a UE and receiving signals transmitted from a UE.

Traditionally, mobile communication networks have been arranged in homogeneous cell structures where each cell has a plurality of non-overlapping neighboring cells. Such a network comprises base stations in a planned layout in which all base stations have similar transmit power levels and antenna patterns. Other types of cell structures allowing for at least partly overlapping cells are known within the art.

In a usual Long Term Evolution, LTE, deployment, a number of base stations, in the following exemplified by eNodeBs, are deployed to provide coverage in a specific area. Each eNodeB can manage a set of cells and all user equipments, UEs, which are in the coverage area of those cells.

From the UE perspective, the cells are distinguished by a physical-layer cell identity, PCI, defined in TS 36.211, ch 6.11. In a normal deployment scenario, neighboring cells have different PCIs and when UEs are in a connected state, i.e. not idle, they use these PCIs as an identifier for handover measurement.

Cell Merge, also called shared cell or multi-sector cell, is a new cell configuration for LTE and enables a multi Radio Resource Unit, RRU, deployment without needing to care about cell planning from a Radio Frequency, RF, perspective. It is achieved by allowing the different RRUs to use the same PCI. Thus, all RRUs are considered, by the UE, to be part of the same cell. The spatially separated RRU or a group of RRUs are called sectors or sector carriers. A cell can contain multiple sectors, and a UE can belong to one sector or multiple sectors depending on the degree of sector isolation. The shared cell has a unique physical-layer cell identity, PCI, which is distinguished by UEs connecting to the cell. The PCI includes cell specific information used by the UEs to derive the structure of the cell and obtain the system information that it needed to connect to the network.

In the LTE, heterogeneous mobile communications network structures have also been considered. Heterogeneous networks provides for a hierarchical cell layer structure with at least two cell layers, wherein low power nodes, e.g. pico/femto/relay base stations, are placed in traffic hot spots or coverage holes within the coverage area of high- or higher-power node, for example a macrocell base station, eNodeB, to better serve nearby mobile devices.

The heterogeneous concept has been seen as a solution to provide higher data rates and traffic capacity to meet expectations of the rapid mobile broadband growth. The macro and low power nodes of the heterogeneous network can be deployed as separate cells or as a shared cell. In the shared cell deployment, the low power nodes are part of the macro cell without creating independent cells for each low power nodes. As previously mention, the shared cell includes a number of sectors, wherein each sector is formed around a transmission point in the shared cell. The sector represents the coverage area of a specific transmission point. In a shared cell in a heterogeneous network deployment, there is one or more transmission points on a macro level and one or more transmission points in each low power node. Consequently, the shared cell includes overlapping sectors with an omnibus sector and local sectors each having an extent of coverage determined by the transmission power of the low power nodes.

In LTE radio access, time-frequency resources are dynamically shared between the users, i.e. shared-channel transmission is applied. A scheduling node controls the assignment of uplink and downlink resources in resource block pairs, each resource block pair including two time-consecutive physical resource blocks, PRBs. The basic operation of the scheduling node is dynamic scheduling, where the scheduling node takes a scheduling decision in each transmission time interval.

Data transmission from several transmission points to one receiving user equipment is enabled. Downlink transmission from multiple transmission points enable transmit diversity, beam forming and spatial multiplexing, each of which provides different benefits to throughput depending on the transmission environment. Downlink spatial multiplexing may be enabled by transmission from physically separated antennas at one transmission point, but also by transmission from antennas located at different transmission points, e.g. by transmission of data from a first transmission point at the macro cell as well as from a second transmission point at a low power node. Transmission from the multiple transmission points enables an increased bit-rate in the data transmission since the spatial multiplexing provides for transmission of multiple streams with different information.

In a cell divided into a set of sectors, downlink spatial division multiplexing has been introduced to improve capacity. In a cell with spatial division multiplexing, the spatial resource is utilized in order to increase the bit-rate. When user equipments are located in spatially separated sectors, transmission can be performed on the same frequency and at the same time, i.e. sharing a physical resource block, given that the sectors are located at such a distance from one another that little or no interference is possible between the two transmissions. Such sectors are described as well isolated to one another. Hence, in this case the transmission in one sectors affect neighboring sectors little or not at all.

There are known methods of scheduling of downlink resources so that sharing of physical resource blocks is enabled between adjacent sectors in a cell, e.g. in a shared cell. However, these methods are not well adapted for cells having one or more overlapping sectors.

### SUMMARY

It is an object of this disclosure to provide a solution to the problem of scheduling downlink resources so that sharing of physical resource blocks is enabled between different sectors in a cell divided into a plurality of sectors. In particular, it is an object of the disclosure to provide a solution to the problem of scheduling downlink resources in a mobile communication network including a plurality of at least partly overlapping sectors, e.g. a heterogeneous network.

The object is achieved by the disclosed method in a scheduling node for selecting a downlink resource allocation scheme in a mobile communication network including a plurality of at least partially overlapping sectors. The selected downlink resource allocation scheme being applicable to downlink data transmission in at least a current transmission time interval to user equipments located in one or more of the plurality of at least partially overlapping sectors. The method comprises selecting a set of user equipments connected to the scheduling node and for each user equipment in the selected set of user equipments, determining sector isolation properties of each sector. A downlink resource allocation scheme is selected wherein at least one sector is disabled for downlink transmission to user equipment in the set of user equipments based on the determined sector isolation properties.

The disclosure enables improved spatial multiplexing in a network including a plurality of at least partially overlapping sectors. The disclosed method is particularly advantageous in a mobile communication network wherein joint transmission from multiple transmission points, in multiple sectors, is possible, e.g. in a shared cell deployment. With the proposed method, it is possible to co-schedule user equipment with spatial multiplexing by disabling downlink transmission on a set of sectors. Such co-scheduling provides the advantage of better spectrum efficiency without compromising quality of service requirements of user equipment.

According to an aspect of the disclosure, the downlink resource allocation scheme is selected for a cell of the mobile communication network.

According to an aspect of the disclosed method, the downlink transmission is a downlink data transmission.

In accordance with a further aspect, the mobile communication network includes a macro high power level and at least one low power level, wherein one or more low power sectors on the low power level are located within a macro level sector on the macro high power level. The macro level sector includes the scheduling node and one or more macro high power data transmission nodes and the low power sectors each include at least one low power data transmission node.

The disclosed method is of particular use in such a heterogeneous mobile communications network.

According to an aspect of the disclosed method, the downlink resource allocation scheme is arranged to allocate resources enabling spatial division multiplexing.

In accordance with yet an aspect of the disclosure, the method includes an introductory step of sorting the user equipments into a scheduling candidate list according to a given priority level, and wherein the step of selecting a set of user equipments comprises selecting the set of user equipments from the candidate list. In a further embodiment, the scheduling candidate list represents a subset of user equipments connected to the scheduling node.

The scheduling candidate list contributes to a faster a more accurate selection of user equipment to schedule according to the disclosed method.

According to a further aspect of the disclosure, the priority level is configurable based on quality of service requirements.

In accordance with another aspect of the disclosure, the step of determining per sector isolation properties for the selected user equipments includes estimating per sector signal quality measures for the selected user equipments and comparing the estimated per sector signal quality measures to one or more given thresholds. Such signal quality measures represents, according to a further aspect of the invention, interference noise ratio values.

In an additional aspect of the disclosure, the signal to interference noise ratio, SINR, values are determined for each sector for each user equipment represented on the scheduling candidates list.

In yet a further aspect of the disclosure, the disabling of the downlink transmission to selected user equipment is achieved by muting downlink transmission in one or more sectors.

In an additional aspect of the disclosure, the method includes a further step of estimating the effect of the selected downlink resource allocation scheme in each subsequent transmission time interval. Following such estimation, the selected downlink resource allocation scheme is maintained, adjusted or rejected.

The object of the disclosure is also achieved through a method of allocating downlink data transmission resources in a mobile communication network, wherein a downlink resource allocation scheme is selected according to any of the previously disclosed aspects of selecting a resource allocation scheme. When a resource allocation scheme has been selected, the method also includes downlink data transmission resources in at least a current transmission time interval according to the selected resource allocation scheme.

A further embodiment of the disclosure relates to a scheduling node in a mobile communication network including a plurality of at least partially overlapping sectors. The scheduling node comprises a memory and a processor, wherein the memory is configured for storing a sector isolation determination algorithm. The processor is configured to select user equipments connected to the scheduling node, to determine per sector isolation for the selected user equipment and to select a downlink resource allocation scheme for the selected user equipments according to the determined per sector isolation properties wherein, in the selected downlink resource allocation scheme, a set of sectors are disabled for downlink transmission to the selected user equipments.

In an aspect of the disclosure, the memory further includes a scheduling candidate list comprising user equipments arranged according to given priority level.

The disclosure also includes a computer program embodiment. The computer program comprises computer program code which, when executed in a scheduling node, causes the scheduling node to execute the disclosed method of selecting a downlink resource allocation scheme in cell in a mobile communication network.

### BRIEF DESCRIPTION OF THE DRAWINGS

FIG. 1a is an illustration of an exemplary heterogeneous mobile communications network.

FIG. 1b is an illustration of a shared or combined cell in a heterogeneous mobile communications network.

FIG. 2 is a flow chart of a method embodiment performed in a scheduling node.

FIG. 3 is message sequence chart illustrating messaging between the scheduling node and user equipment.

FIG. 4 is a block diagram of a scheduling node.

FIG. 5 exemplifies scheduling results when scheduling according to the resource allocation scheme.

### DETAILED DESCRIPTION

The general object or idea of embodiments of the present disclosure is to address at least one or some of the disadvantages with the prior art solutions described above as well as below. The various steps described below in connection with the figures should be primarily understood in a logical sense, while each step may involve the communication of one or more specific messages depending on the implementation and protocols used.

Embodiments of the present disclosure relate, in general, to the field of downlink scheduling in a Long Term Evolution, LTE, heterogeneous network. However, it must be understood that the proposed techniques can be further extended to any type of mobile communications network involving a plurality of at least partly overlapping sectors belonging to a shared cell. According to a basic concept of the disclosure, transmission on the same time and frequency resources is selected for user equipment belonging to different sectors that are well isolated from one another.

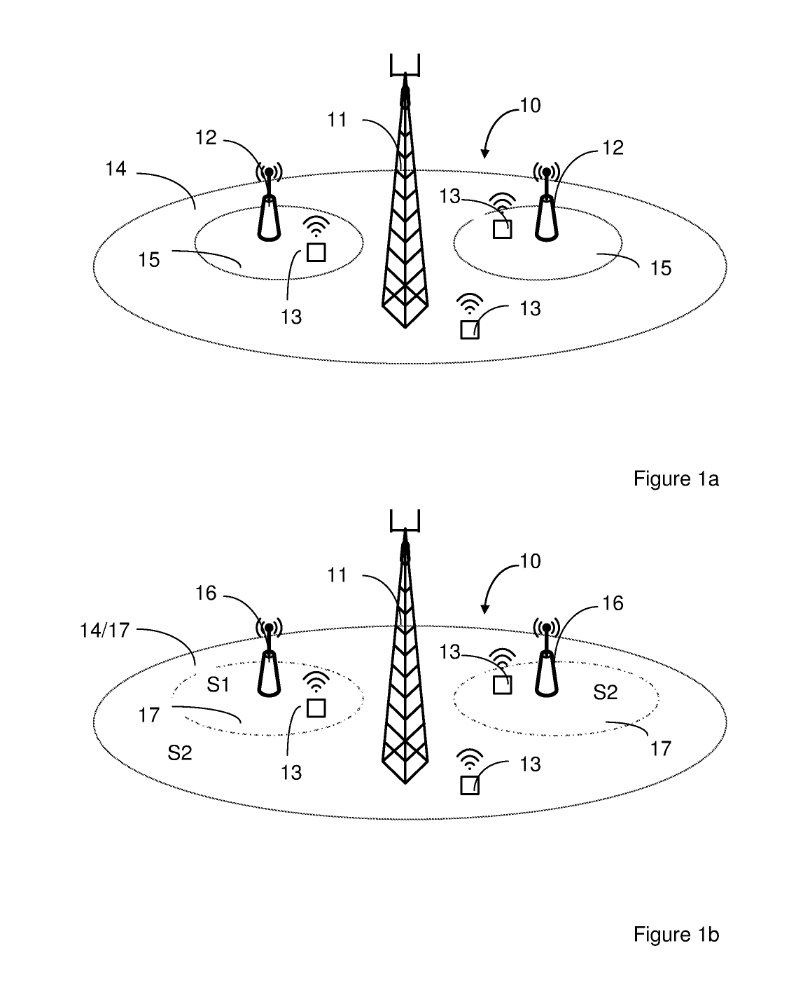

FIG. 1a illustrates an exemplary heterogeneous mobile communications network 10. In the heterogeneous network 10, low power nodes, e.g pico nodes 12, are placed throughout a macro node layout. In the illustrated network, the macro node 11 and pico nodes 12 are be deployed as separate cells requiring a separate cell identity for each cell corresponding to a respective node.

FIG. 1b illustrates an exemplary heterogeneous mobile communication network 10 deployed with a shared cell layout. In the shared cell deployment, the disclosed pico nodes 16 and macro node 11 share the same cell identity. The area covered by a respective node is known as a sector 17 in the shared cell deployment.

There are several benefits with a shared cell deployment. In the shared cell deployment, it is possible to transmit control information in a macro sector S2 to provide basic coverage, e.g. system information, control and reference signals. The pico nodes are deployed to transmit data enhancing capacity and data rates. With a reduced number of cells, there is less concern about intercell interference resulting in an easier cell planning. Since there is no need for handover within the shared cell, the control signaling is reduced. The shared cell 14 also provides for an improved signal quality and higher spectrum efficiency since it is possible to perform joint reception from different sectors and multi-point transmission.

However, when combing different cells into one cell with a common physical cell identity, PCI, the capacity will be limited by the cell specific physical resources, such as bandwidth. In order to improve capacity, Spatial Division Multiplexing, SDM, is introduced. In a shared cell with SDM, the spatial resource is utilized. User equipments that are spatially separated can use the same time and frequency resource, but on different sectors. Such sectors are described as well isolated sectors. The reuse of time and frequency resources in different sectors enables significantly increased spectrum efficiency (bits/Hz).

In state of the art solutions for selecting sectors wherein such reuse of resources may be allowed, the sector selection is based on individual channel quality and isolation degree for user equipment; the isolation degree measured by the difference of the channel quality in different sectors of the user equipment. The sector that has a best channel quality will always be selected. A problem with this solution is that it is not well optimized for a mobile communication network including at least partly overlapping sectors, such as in a heterogeneous network. With previously used solutions for sector selection, a sector overlapping at least one other sector is commonly selected as the primary or secondary sector. With the overlap, selection of the overlapping sector as a primary or secondary sector prohibits spatial reuse of the time and frequency resources wasting valuable physical resources and limiting the overall system capacity.

The present disclosure proposes a novel scheme for spatial division multiplexing wherein downlink transmission to user equipment in an overlapping sector is disabled, e.g. by muting the transmission, thereby increasing the isolation between the remaining sectors.

The disclosure is made with reference to the shared cell deployment according to FIG. 1b, but is not limited to a shared cell deployment. The disclosure is applicable to any type of network in which joint transmission from multiple transmission points/sectors to one user equipment is enabled. The disclosed method is applicable to a set of user equipments 13 present in a cell 14 of mobile communication network 10. The cell 14 includes three sectors 17 that are at least partially overlapping so that two low power sectors S1, S3 overlap with a macro level sector S2. The two low power sectors S1, S3 are non-overlapping. If a sector S1; S3 in the shared cell is well isolated from another sector S3; S1 in the cell, user equipment 13 connecting to these mutually isolated sectors may communicate on the same time and frequency resource.

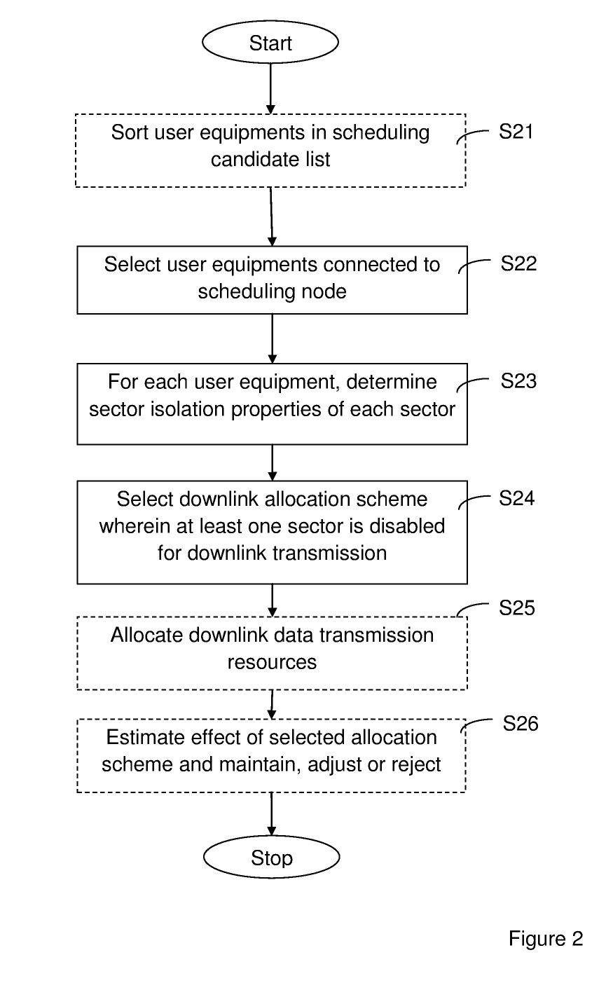

FIG. 2 discloses a flow chart of a method embodiment performed in a scheduling node 11. In a first optional scheduling preparation phase, the user equipment 13 belonging to the cell 14 of the scheduling node 11, e.g. connected or attached to the scheduling node 11, is sorted in a scheduling candidates list according to a priority level S21. A scheduling candidate is a UE 13 and it is also called scheduling entity, SE. The priority level is configured by operator based on QoS requirements. The scheduling candidate list could include a list of all user equipments connected to the scheduling node with assigned priority levels. According to one aspect, the scheduling candidate list is limited to a subset of user equipments connected to the scheduling node.

In step S22, user equipment connected to the scheduling node is selected. As disclosed in S22 it is possible to select user equipments 13 without the preparatory step of sorting S21 the user equipments in a scheduling candidate list. When the set of user equipments has been sorted in a scheduling candidate list, the user equipment selected in step S22 is selected from the scheduling candidate list. Following the selection S22 of UEs 13, the isolation property for each selected user equipment, e.g. the scheduling candidate from the scheduling candidates list, is determined in step S23. The determination is made from an estimation of per sector based signal to interference and noise ratio, SINR, performed in the scheduling node 11 for each selected UE. The isolation properties for the selected user equipment are determined for each sector S1-S3 in the cell 14, by determining Signal to Noise and Interference, SINR, received power, estimated bit rate or any other state of the art channel quality indicator.

According to one aspect of this disclosure, the output of the estimation in the scheduling node, is a vector S_{u,i} where each element represent one sector i for a UE u. 1 indicates that the corresponding sector i is selected for reception. 0 indicates that the UE cannot be heard/scheduled in the sector i. When there is poor isolation among the selected sectors, multiple sectors are selected and the UEs perform joint reception on the selected sectors. S_{u,i} is calculated based on the filtered channel quality Q_{u,i} of scheduling entity u in sectors i, and one example Q_{u,i} is the received signal power.

| | For u=0, . . . , N−1 | | | | | | |
|---|---|---|---|---|---|---|---|
| | | ∘ | Calculate | | | | |
| | | | ${Q}_{u , max} = {max}_{i} ( {Q}_{u , i} ) ,$ | | | | |
| | | | i = 0 . . . I−1 and set primarySectorIndex = i | | | | |
| | | ∘ | for i = 0 . . . I−1 | | | | |
| | | | | ▪ | Calculate Du,i = Q_{u,max} − Q_{u,i} | | |
| | | | | ▪ | if Du,i >TH | | |
| | | | | | | | Su,i = 0 |
| | | | | ▪ | Else | | |
| | | | | | | | Su,i = 1 |

| | |
|---|---|
| ▪ | End if |

The Signal to Noise and Interference Ratio, SINR, value is computed for each sector. The SINR_{u,i} for user u and sector i is computed based on a UE Reference Symbol Received Power, RSRP, report, RSRPᵤ and a channel quality indicator, CQI, report, CQIᵤ. A filtered Sounding Reference Signal, SRS, gain measurement G^{SRS}_{u,i} of user u at sector i is assumed to be equal to the downlink path loss of user u on sector i, furthermore it is assumed that the UE experiences the same interference from all sectors. The SINR_{u,i} for user u and sector i is then computed based on the below equation:

$$\begin{matrix}{SINR}_{u , i} = \frac{{P}_{tx , i} \cdot {G}_{u , i}^{SRS}}{{( I + N )}_{u}} \cdot {G}_{outerLoop , u} \\ = \frac{{P}_{tx , i} \cdot {G}_{u , i}^{SRS} \cdot {CQI}_{u}}{{RSRP}_{u}} \cdot {G}_{outerLoop , u}\end{matrix}$$

$${Where \\ ( I + N )}_{u} = \frac{{CQI}_{u}}{{RSRP}_{u}}$$

$$• end for$$

$$• end for$$

The scheduling node then estimates the signal to noise interference ratio, SINR, value for UEu if no muting is applied.

 For u=0,...,N−1

◯ Initialize SINRᵤ =0;
◯ for i=0...l−1

| ▪ | if Su,i ==1 |
|---|---|
| | SINRᵤ = SINRᵤ + SINR_{u ,i} |
| ▪ | end if |

◯ end for

 end for

The scheduling node evaluates the throughput of the two UEs. The Transport Block Size, TBS, is estimated for UEs when none of the sectors of a UE is muted and the spectrum is shared equally by the UEs, e.g. by checking a TBS table.

The throughput of UE u can be obtained as:

TBSu=Ru*B/Nv

where B is the total bandwidth that can be used by the coordinated UEs. V is used to denote a set of UEs to be coordinated. And Nv is the number of UEs that needs to be coordinated and belongs to V.

The cost metric defined as the total throughput is the summation of the TBS of the users which need to be coordinated among the sectors.

$${C}^{′} = {\sum }_{u ∈ V} {TBS}_{u}$$

Then the scheduling node computes the TBS of user u if the overlapped sector is muted, TBS′u. Since PDSCH is only transmitted in the sector which is isolated to the other UE, full bandwidth B is used by both UEs. To do so, scheduling node first estimates the SINR′u value the user u after muting. It is done by subtracting the SINRu,i on the muted sector from the SINRu.

SINR′u=SINRu−SINRu,i

Similarly, the scheduling node estimates the TBS of both UEs by checking the raw bit information table SINR′u. Based on SINR′u of user u, the R′u can be obtained from a TBS table. The TBS of user u after muting is given as below

TBS′u=R′u*B

The total throughput is the summation of the TBS of the users which need to be coordinated V.

$${C}^{′} = {\sum }_{u ∈ V} {TBS}_{u}^{′}$$

Hence, a downlink resource allocation scheme wherein a set of sectors are disabled for downlink transmission to selected user equipment is selected in step S24 based on the determined sector isolation properties. In an exemplifying embodiment, the disabled sectors are accomplished by muting transmission in these sectors.

The selection of the downlink resource allocation scheme, in the following known as the scheduling decision is made by comparing an estimated total throughput C′ following muting of one or more sectors and an estimated total throughput C without muting.

When the estimated total throughput without muting C equals or exceeds an estimated total throughput with muting, no muting is to be performed. Depending on the resource allocation strategy specified by operator, it is possible to transmit the two UEs in the same subframe but only using part of spectrum, multiplexing in frequency; or it is also possible to transmit to the UEs with highest priority for full bandwidth and the lower priority UEs will be scheduled in the next subframe, multiplexing in time.

In the opposite situation, when the estimated throughput following muting exceed an estimated throughput for the unmuted transmission, a downlink allocation scheme including one or more muted sectors for the UEs is selected in step S24 and transmission is enabled only on the isolated sectors for the UEs.

When a resource allocation scheme has been selected, downlink data transmission resources are allocated in step S25. The downlink data transmission resources are for example a physical downlink shared channel, PDSCH.

The downlink resource allocation scheme is selected on a per packet basis or for a set of transmission time intervals. Based on the user equipment response, the downlink resource allocation scheme is maintained, adjusted or rejected in step 26.

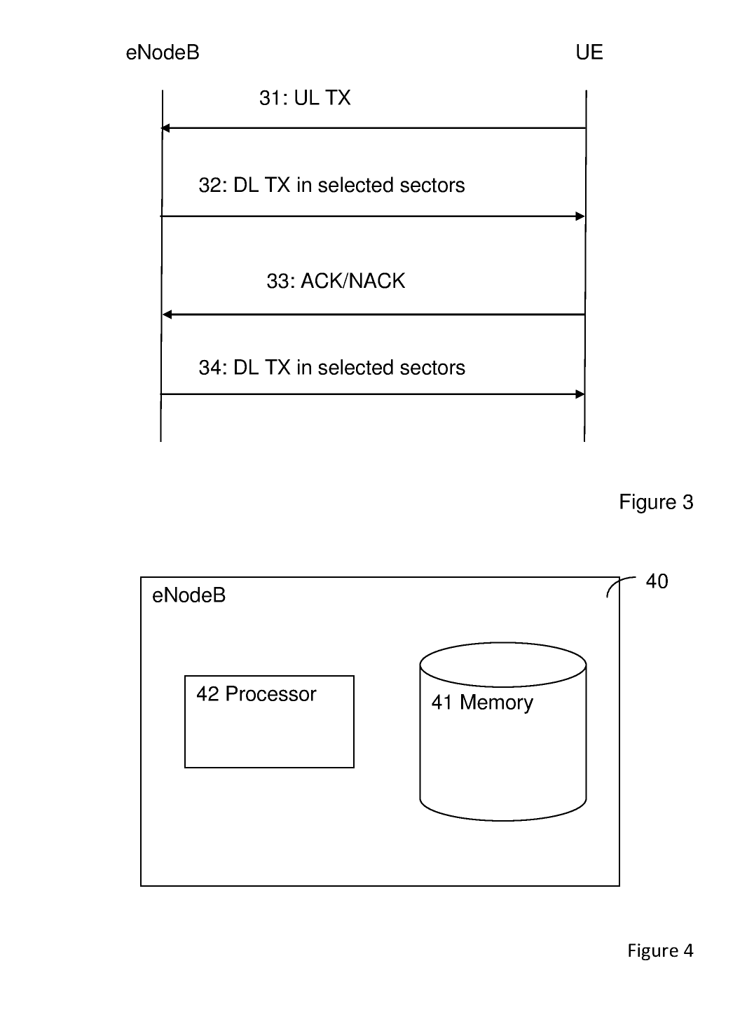

FIG. 3 is message sequence chart illustrating messaging between the scheduling node and user equipment, UE.

The scheduling node, here illustrated as an eNodeB, receives a first uplink transmission message 31 from the UE, e.g. any of the messages SRS, PUSCH, PRACH or PUCCH. The eNodeB measures the received power of the uplink transmission, filters the received power, and makes a sector selection for next PDSCH transmission according to a downlink resource allocation scheme selected based on determined sector isolation properties as explained above.

The eNodeB transmits downlink PDSCH data 32 in accordance with the selected downlink resource allocation scheme, i.e. transmits PDSCH data in the selected sectors.

The receiving UE decodes the PDSCH data and sends ACK/NACK information 33 indicating if data is correctly received.

The eNodeB receives the ACK/NACK. Based on the result of the previous downlink transmission in selected sectors, the eNodeB is capable of adjusting, maintaining or rejecting the downlink resource allocation scheme. Following possible adjustments, the eNodeB transmits new PDSCH data 34 in selected sectors.

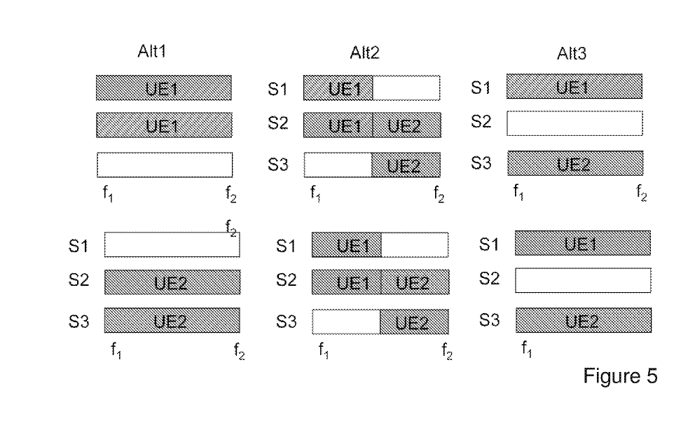

FIG. 5 is a block diagram of a scheduling node. The disclosed scheduling node 11, 40 is arranged for use in a mobile communication network 10 including a plurality of at least partially overlapping sectors 17. The scheduling node 11, 40 comprises a memory 41 for storing the disclosed sector isolation determination algorithm. The scheduling node 11, 40 further includes a processor 42 configured to select user equipments 13 connected to the scheduling node 11 and to determine sector isolation properties of each sector for the selected user equipment. The processor is further arranged to select a downlink resource allocation scheme wherein at least one sector S1-S3 is disabled for downlink transmission to user equipment in the set of user equipments based on determined sector isolation properties.

FIG. 6 exemplifies scheduling results when scheduling according to a selected resource allocation scheme. Alt 3 discloses scheduling according to a resource allocation scheme wherein one sector S2 is disabled for downlink transmission. The overlapped sector, S2, is muted for both UE1 and UE2 and both UEs are transmitted in all sub-frames. In Alt 1 and Alt 2, both sectors are selected, but UE1 and UE2 are multiplexed either in time or in frequency depending on the time frequency resource allocation strategy. In Alt 1, UEs are multiplexed in time and in Alt 2, UEs are multiplexed in frequency.

The above detailed description has addressed embodiments in a LTE network. However, the disclosure is also applicable to a GSM or UMTS network.

1. A method in a scheduling node for selecting a downlink resource allocation scheme in a mobile communication network including a plurality of at least partially overlapping sectors, the selected downlink resource allocation scheme being applicable to downlink transmission in at least a current transmission time interval to user equipments located in a one or more of the plurality of at least partially overlapping sectors, the method comprising:
selecting a set of user equipments connected to the scheduling node;
for each user equipment in the selected set of user equipments, determining sector isolation properties of each sector; and
selecting a downlink resource allocation scheme, wherein at least one sector is disabled for downlink transmission to user equipment in the set of user equipments based on determined sector isolation properties.

2. The method according to claim 1, wherein the downlink transmission is downlink data transmission.

3. The method according to claim 1, wherein the downlink resource allocation scheme is selected for a cell of the mobile communication network.

4. The method according to claim 1, wherein the mobile network includes a macro high power level and at least one low power level, wherein one or more low power sectors on the low power level are located within a macro level sector on the macro high power level and wherein the macro level sector includes the scheduling node and one or more macro high power data transmission nodes and the low power sectors (S1, S3) each include at least one low power data transmission node.

5. The method according to claim 1, wherein the downlink resource allocation scheme is arranged to allocate resources enabling spatial division multiplexing.

6. The method according to claim 1, further including sorting the user equipments into a scheduling candidate list according to a given priority level, and wherein the step of selecting a set of user equipments comprises selecting the set of user equipments from the scheduling candidate list.

7. The method according to claim 6, wherein the priority level is configurable based on quality of service requirements.

8. The method according to claim 6, wherein the scheduling candidate list represents a subset of user equipments connected to the scheduling node.

9. The method according to claim 1, wherein the step of determining sector isolation properties of each sector for the selected user equipments includes estimating signal quality measures of each sector for the selected user equipments and comparing the estimated signal quality measures to one or more given thresholds.

10. The method according to claim 9, wherein the signal quality measures represent signal to interference noise ratio, SINR, values.

11. The method according to claim 10, wherein the SINR values are determined for each sector and for each user equipment represented on the scheduling candidates list.

12. The method according to claim 1, further including the step of estimating the effect of the selected downlink resource allocation scheme in each subsequent transmission time interval whereupon the selected downlink resource allocation scheme is maintained, adjusted or rejected.

13. The method according to claim 1, further including the step of
allocating downlink transmission resources in at least a current transmission time interval according to the selected resource allocation scheme.

14. A scheduling node in a mobile communication network including a plurality of at least partially overlapping sectors, the scheduling node comprising:
a memory for storing a sector isolation determination algorithm, and
a processor configured to:
select user equipments connected to the scheduling node,
determine sector isolation properties of each sector for the selected user equipment, and
select a downlink resource allocation scheme wherein at least one sector is disabled for downlink transmission to user equipment in the set of user equipments based on determined sector isolation properties.

15. The scheduling node according to claim 14, wherein the memory further includes a scheduling candidate list comprising user equipments arranged according to given priority level.

16. Logic embodied in a non-transitory computer readable medium which, when executed in a scheduling node, causes the scheduling node to
select user equipments connected to the scheduling node,
determine sector isolation properties of each sector for the selected user equipment, and
select a downlink resource allocation scheme wherein at least one sector is disabled for downlink transmission to user equipment in the set of user equipments based on determined sector isolation properties.
